(19) United States
(12) Patent Application Publication
(10) Pub. No.: US 2014/0190262 A1
(43) Pub. Date: Jul. 10, 2014

(54) FEEDING DEVICE FOR AN ULTRASOUND INSPECTION SYSTEM

(71) Applicants: Damian Meinert, Langenfeld (DE); Stephan Schmitz, Cologne (DE)

(72) Inventors: Damian Meinert, Langenfeld (DE); Stephan Schmitz, Cologne (DE)

(73) Assignee: GE SENSING & INSPECTION TECHNOLOGIES GMBH, Hurth (DE)

(21) Appl. No.: 13/811,311

(22) PCT Filed: Jul. 14, 2011
(86) PCT No.: PCT/EP2011/062030

§ 371 Date: Mar. 14, 2013

(30) Foreign Application Priority Data
Jul. 21, 2010 (DE) 10 2010 031 637.7
Aug. 5, 2010 (DE) 10 2010 038 973.0

(51) Int. Cl. G01N 29/22

(52) U.S. Cl. CPC G01N 29/225
USPC 73/584; 226/196.1

(57) ABSTRACT

The invention relates to a feeding device for an ultrasound inspection system, with means for transporting a test object (7), in particular a pipe, into an ultrasound inspection chamber of the ultrasound inspection system, comprising at least one guiding unit (1) for the test object with at least one, preferably three, still more preferably six elastically biased counter bearings (2) resting against a jacket surface (8) of the test object (7) via a contact part (4) in order to guide the test object during transport.

The invention relates to a feeding device for an ultrasound inspection system.

Guiding devices for guiding test objects in ultrasound inspection systems are known from the prior art. For example, DE 19931350 B4 discloses an inspection device for the ultrasound inspection of bar stock in which guiding means are provided on both end faces of the tubular container. The guiding means are thus configured for guiding the bar to be inspected in such a way that the bar to be inspected is disposed substantially concentrically with the cylinder axis. The guiding means can be assembled from two semi-annular portions.

Furthermore, a device for the non-destructive inspection of elongated test pieces with ultrasonic pulses is known from the utility model DE 7933989 U1, wherein a mutual guidance of the test piece and the test chamber is accomplished by means of guiding bushes.

The aforementioned documents are disadvantageous in that the guiding bushes must be replaced if the transverse dimension of the test objects changes.

Since faulty results occur during ultrasound inspection if the test objects are not fed into the ultrasound inspection chamber of the ultrasound inspection system in a centered manner, it is the object of the present invention to provide a simple and reliable feeding device. Moreover, it is an object of the present invention to enable a reliable ultrasound inspection of test objects with a changing cross section.

This object is accomplished by means of a feeding device with the features of claim 1, an ultrasound inspection system according to claim 11, and a method for ultrasound inspection according to claim 14. Advantageous embodiments are in each case the subject matter of the dependent claims. It must be remarked that the features cited individually in the patent claims can be combined in any technologically meaningful manner and depict other embodiments of the invention. The description, in particular in connection with the figures, additionally characterizes and specifies the invention.

The invention relates to a feeding device for an ultrasound inspection system with means for transporting a test object, in particular a pipe, into an ultrasound inspection chamber of the ultrasound inspection system. The feeding device according to the invention comprises at least one guiding unit with at least one, preferably three, still more preferably six elastically biased counter bearings. The counter bearings, via contact parts, rest on the jacket surface of the test object and guide the test object during transport.

The feeding device according to the invention is advantageous in that the test object is thereby fed into the ultrasound inspection chamber in a centered manner and that the ultrasound inspection can thus supply reliable results.

According to the invention, the counter bearings can be uniformly disposed in the circumferential direction of the jacket surface of the test object. In order to achieve an optimum distribution of the weight of the test object on the counter bearings, it is, however, also conceivable that the counter bearings are non-symmetrically disposed in the circumferential direction of the jacket surface; in this case, it is advantageous in particular if the majority of the counter bearings used are disposed under the test object.

In an advantageous embodiment of the invention, a spring, preferably a leaf spring and/or a rubber buffer, is provided as the means for elastically biasing the counter bearing in the direction of the test object. Preferably, this means can be individually biased, for example by a threaded adjustment option. It is thus possible to bias the counter bearings in a non-symmetrical way, for example, to bias those that rest against the lower side of the jacket surface of the test object more strongly than those counter bearings resting against the upper half of the jacket surface.

For the present invention, springs of spring steel are preferably used, such as e.g. the spring steel 38Si7. However, using other materials with an even higher elastic limit is also conceivable.

In an advantageous embodiment of the present invention, the counter bearings moreover have damping means. Damping means dampen the return movement of the counter bearing. The damping property is, for example, a property inherent in the rubber material used.

A rubber buffer which has a cross section that changes in the direction of the load is preferably used as an elastic returning means. The rubber buffer can be designed to have a conical, preferably parabolic, shape.

Natural rubbers are particularly suitable as materials for the rubber buffer. In a preferred embodiment, the rubber buffer has a Shore hardness of about 55. However, the use of any other material that exhibits an elastically dampening behavior is also conceivable.

In order not to damage the surface of the test object while it is guided through the ultrasound inspection system, the contact part preferably has to be designed in such a way that there is as little surface pressure as possible. This can be achieved, among other things, by as large a contact surface as possible between the contact part and the test object. In a preferred embodiment, the contact part is formed from a harder material than the test object; materials with a Rockwell hardness of at least 60 HRC, preferably at least 64 HRC, are particularly suitable for this purpose. However, it is also conceivable that a contact part of plastic is used.

According to a preferred embodiment, the contact part comprises a run-up surface. A run-up surface means a surface of the contact part which is inclined towards the direction of transport, in order to cause the contact part to pivot against the bias at least when the test object is inserted.

In an advantageous embodiment of the invention, the contact parts can be double-wedge bodies, preferably non-symmetrical double-wedge bodies. By using double-wedge bodies as contact parts, two run-up surfaces are defined and there is the option of feeding or transporting the test object not only in one direction, but in both directions. This is particularly advantageous if the test object has to be moved back and forth, for example if an area of the test object has to be re-inspected with ultrasound. The test object does not have to be guided out of the ultrasound inspection system completely and transported to the inlet of the ultrasound inspection system anymore. The test object can simply be moved back to the area to be inspected.

The method according to the invention is particularly suitable for the ultrasound inspection of rods and pipes. Preferably, pipes with a cross section that changes in the longitudinal direction, in this case particularly pipes with a thickened end, particularly preferably upset end pipes, are examined with the method according to the invention. Because of the elastic properties, the counter bearing or counter bearings adapt optimally to the different diameters of the test objects and position the test objects centrally in the ultrasound inspection system. However, it is also conceivable to examine other axially-symmetrical test object, such as, for example, a hexagon or nonagon with the ultrasound inspection method.

In the present invention, the test objects cause the counter bearings to pivot. Therefore, no external drives, such as motors, are required that increase the susceptibility to failure of the ultrasound inspection system.

Test objects with various diameters or cross sections can be examined with the ultrasound inspection system according to the invention. The pipes to be examined can have a diameter of a few centimeters, preferably smaller than 50 mm, particularly smaller than 80 mm.

An ultrasound inspection system in which the feeding device according to the invention is located outside the ultrasound inspection chamber must be considered particularly advantageous. On the one hand, this construction enables an easier access to the individual elements of the ultrasound inspection system. On the other hand, the ultrasound inspection chamber is used exclusively for ultrasound inspection, so that the inspection yields more reliable results.

The invention as well as the technical environment is explained in more detail below with reference to the figures. It must be remarked that the Figures depict a particularly preferred embodiment of the invention, but that they are not limited thereto. In the figures:

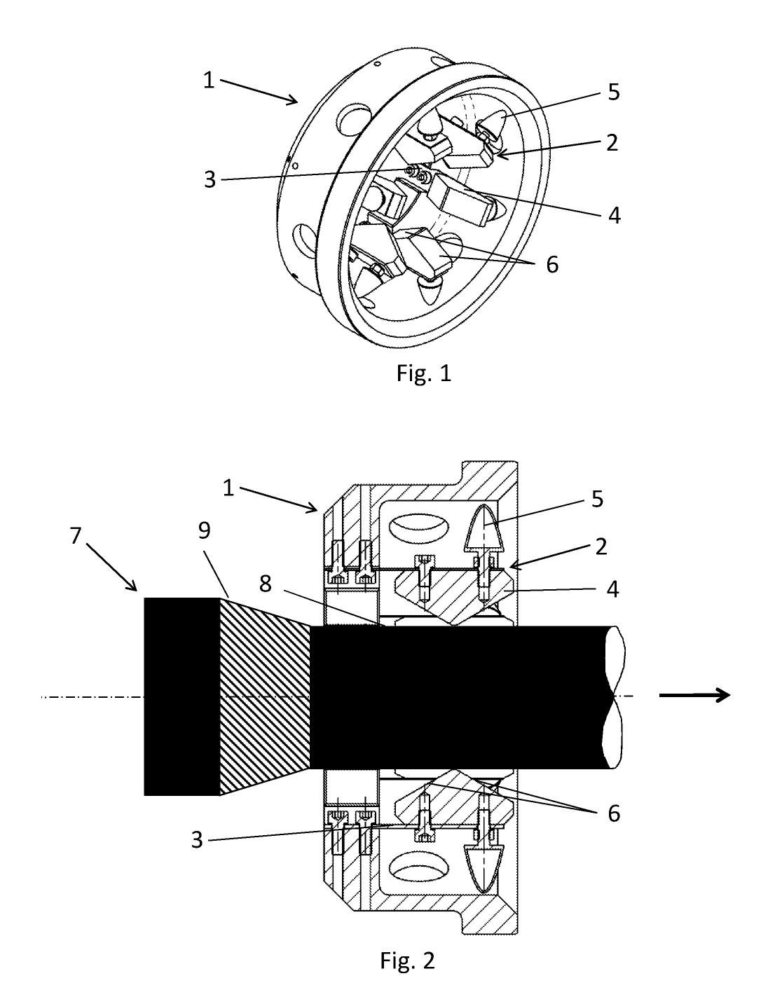

FIG. 1: shows a schematic view of the feeding device according to the invention shown in a preferred embodiment;

FIG. 2: shows a schematic sectional view of a feeding device according to the invention in a preferred embodiment.

The figures show schematic views of a preferred embodiment of the present invention. The feeding device for an ultrasound inspection system comprises at least one guiding unit (1), preferably with elastically biased counter bearings (2) resting against a jacket surface (8) of the test object (7) via a contact part (4). The contact parts (4) can be configured as double wedges (4) in a preferred embodiment. In FIG. 2, the double wedge (4) has a symmetric structure; it has two run-up surfaces (6) of equal size. In addition to the contact part (4), the counter bearings (2) comprise a leaf spring (3) and a rubber buffer (5). The rubber buffer (5) is conical and has a Shore hardness of 55. The counter bearings (2) are elastically biased by the leaf spring (3) and the rubber buffer (5). In FIG. 2, it can be seen how the counter bearings (2) rest on the jacket surface (8) of the test object (7). If the test object (7) is transported in the direction of the arrow, the counter bearings (2) slide with the run-up surfaces (6) of the contact parts (4) over the jacket surface (8). When the test object (7) with its thickened ends (9) reaches the counter bearings (2), they are pushed in an outward direction and pivoted against the bias.

1.-17. (canceled)

18. A feeding device for an ultrasound inspection system with means for transporting a test object, in particular a pipe, into an ultrasound inspection chamber of the ultrasound inspection system, the feeding device comprising:
at least one guiding unit for the test object with at least three elastically biased counter bearings resting against a jacket surface of the test object via a contact part in order to guide the test object during transport,
wherein the counter bearing, as a means for elastically biasing it, comprises a rubber buffer and in that the rubber buffer exhibits a change of the cross section in the direction of the load.

19. The feeding device according to claim 18, wherein the several counter bearings are uniformly distributed in the circumferential direction of the jacket surface of the test object.

20. The feeding device according to claim 18, wherein the contact part is substantially wedge-shaped.

21. The feeding device according to claim 18, wherein the contact part is a double-wedge body.

22. The feeding device according to claim 21, wherein the contact part is a non-symmetrical double-wedge body.

23. The feeding device according to claim 18, wherein the contact part is made from metal.

24. The feeding device according to claim 18, wherein the contact part is made from plastic.

25. The feeding device according to claim 18, wherein the contact part has a hardness of at least 64 HRC.

26. The feeding device according to claim 18, wherein the counter bearing has a damping means.

27. The feeding device according to claim 18, wherein the counter bearing, as a means for elastically biasing it, comprises a spring.

28. The feeding device according to claim 18, wherein the rubber buffer is configured to have a conical or parabolic shape.

29. An ultrasound inspection system comprising:
a feeding device with means for transporting a test object, in particular a pipe, into an ultrasound inspection chamber of the ultrasound inspection system, the feeding device including:
at least one guiding unit for the test object with at least three elastically biased counter bearings resting against a jacket surface of the test object via a contact part in order to guide the test object during transport,
wherein the counter bearing, as a means for elastically biasing it, comprises a rubber buffer and in that the rubber buffer exhibits a change of the cross section in the direction of the load.

30. The ultrasound inspection system according to claim 29, wherein the feeding device is located outside the ultrasound inspection chamber.

31. The ultrasound inspection system according to claim 29, wherein a rubber collar is furthermore provided for sealing the ultrasound inspection chamber.

32. A method for ultrasound inspection, the method comprising:
feeding a test object into an ultrasound inspection chamber of an ultrasound inspection system using a feeding device, and
inspecting the test object with ultrasound,
wherein the feeding device includes:
with means for transporting a test object, in particular a pipe, into an ultrasound inspection chamber of the ultrasound inspection system, and
at least one guiding unit for the test object with at least three elastically biased counter bearings resting against a jacket surface of the test object via a contact part in order to guide the test object during transport,
wherein the counter bearing, as a means for elastically biasing it, comprises a rubber buffer and in that the rubber buffer exhibits a change of the cross section in the direction of the load,

33. The method according to claim 32, wherein the test object is a pipe with a cross-section changing in the longitudinal direction.

34. The method according to claim 33, wherein the pipe is an upset end pipe.
